(19) United States
(12) Patent Application Publication
(10) Pub. No.: US 2021/0238752 A1
(43) Pub. Date: Aug. 5, 2021

(54) STABILIZED HYPOCHLOROUS ACID

(71) Applicants: Emmett Manuel CUNNINGHAM, Glen Allen, VA (US); Marc Joel EPSTEIN, Long Branch, NJ (US)

(72) Inventors: Emmett Manuel CUNNINGHAM, Glen Allen, VA (US); Marc Joel EPSTEIN, Long Branch, NJ (US)

(21) Appl. No.: 16/972,537

(22) PCT Filed: Jun. 5, 2019
(86) PCT No.: PCT/US2019/035657

§ 371 Date: Dec. 4, 2020

Related U.S. Application Data
(60) Provisional application No. 62/681,599, filed on Jun. 6, 2018.

(51) Int. Cl. C25B 1/50; C25B 1/26; C01B 11/04; A01N 59/00; A01N 25/22

(52) U.S. Cl. CPC C25B 1/50; C25B 1/26; A01N 25/22; A01N 59/00; C01B 11/04

(57) ABSTRACT

The invention relates generally to disinfecting solutions and, more particularly, to stabilized Hypochlorous acid solutions, their production, and use. One embodiment of the invention provides a method of preparing a Hypochlorous acid solution, the method comprising: electrolyzing a salt solution of purified water and substantially pure sodium chloride to form a Hypochlorous acid solution; introducing into the Hypochlorous acid solution a quantity of carbon dioxide gas; and introducing into the Hypochlorous acid solution a quantity of sulfamic acid.

### CROSS-REFERENCE TO RELATED APPLICATIONS

This application claims the benefit of co-pending U.S. Provisional Patent Application Ser. No. 62/681,599, filed 6 Jun. 2018, which is incorporated herein as though fully set forth.

### BACKGROUND

Since its inception in the early 1970s, a solution derived from the electrolization of a mild sodium chloride and water mixture into a strong disinfectant (often called “Anolyte”), industry has longed for an effective Hypochlorous acid disinfectant that would maintain shelf stability for more than a few weeks. Household bleach (NaClO) has long been available and used to create disinfection solutions, but the shelf stability of bleach is a function of its extremely high pH, which preserves the chlorine, albeit in a form not available for effective disinfection. As used herein, the terms “shelf-stable” or “shelf stability” refer to the ability of a solution to maintain at least about 90% of its original disinfecting power for a particular period of time. A solution deemed “shelf-stable” for one year, for example, would retain at least about 90% of its original disinfecting power one year after production, assuming storage at normal room temperature and in the absence of strong light.

With such a short shelf/effective life, the need to produce Hypochlorous acid on site became the only viable solution. This created an industry in itself, producing and selling expensive machines that had to be maintained on location, e.g., in hospitals, schools, nursing homes, military facilities, etc. This invention/process answers both the need for a shelf stable, dependable chorine disinfectant and the end of a requirement for “on location” electrolyzing machines.

In a chemical reaction, chemical equilibrium is the state in which both reactants and products are present in particular concentrations that have no further tendency to change over time. Usually, this state results when the forward reaction proceeds at the same rate as the reverse reaction. The reaction rates of the forward and backward reactions are generally not zero, but equal. Thus, there are no net changes in the concentrations of the reactant(s) and product(s). This state is commonly referred to as the dynamic equilibrium.

The goal of sanitarians is to maximize disinfection performance while minimizing the time required and damage to personnel, equipment, and products. Shelf-stable Hypochlorous acid would achieve these goals.

### SUMMARY

One embodiment of the invention provides a method of preparing a Hypochlorous acid solution, the method comprising: electrolyzing a salt solution of purified water and substantially pure sodium chloride to form a Hypochlorous acid solution; introducing into the Hypochlorous acid solution a quantity of carbon dioxide gas; and introducing into the Hypochlorous acid solution a quantity of sulfamic acid.

Another embodiment of the invention provides a liquid solution comprising: Hypochlorous acid as the predominant chlorine species, wherein the solution has a pH between about 6.0 and about 7.0 and is shelf-stable for up to one year.

### DETAILED DESCRIPTION

A mixture may appear to have no tendency to change, though it is not at equilibrium. For example, a mixture of HOCl and NaCl is metastable as there is a kinetic barrier to formation of a stable product.

The barrier can be overcome when catalyst inhibitors, such as carbon dioxide (CO₂) and Sulfamic acid (H₃NSO₃), are also present in the mixture but do not affect the equilibrium concentrations. One can achieve dynamic equilibrium almost instantaneously in the presence of the catalytic inhibitors reaction of carbon dioxide/sulfamic acid and HOCl/NaCl.

According to some embodiments of the invention, the addition of sulfamic acid, in conjunction with the carbon dioxide, forms combined catalytic inhibitors that do no affect the efficacy of the Hypochlorous acid as a disinfectant. At the same time, the Sulfamic acid prevents the Hypochlorous acid from disassociating from the solution as chlorine gas and/or recombining into either sodium hypochlorite or sodium chloride. In addition, the addition of sulfamic acid further lowers the pH of the solution to 4-7 pH, enhancing the killing power of the resulting Hypochlorous acid (HOCl). The shelf-life of the resulting solution is comparable to sodium hypochlorite, i.e., household bleach.

Carbon dioxide as a gas has an extremely limited ability to remain in solution at standard temperatures and atmospheric pressures. Thus, its use constitutes an extremely delicate and exacting method of lowering pH. Combining the carbon dioxide with Sulfamic acid creates dual catalytic inhibitors providing a low pH chlorine solution in the form of Hypochlorous acid that is stable in a way that is similar to sodium hypochlorite at pH 12-13.

According to embodiments of the invention, shelf-stable Hypochlorous acid (SS-HOCl) is manufactured utilizing a device that breaks down (electrolyzes) a salt solution (NaCl and water) into chlorine (Cl), water, sodium chloride (NaCl), and sodium hydroxide (NaOH) at a pH of 5-7. Applicant's process has been shown to be capable of controlling: 1) the resulting sodium hypochlorite strength, 2) salt load, 3) processing time, 4) temperature, and 5) the overall purity of the mixture. The exacting introduction of carbon dioxide into the final solution lowers the pH of the liquid to 6-7 (±0.5 pH), thus transforming the solution from a relatively weak sodium hypochlorite into a stronger Hypochlorous acid solution in terms of its disinfecting properties, i.e., the availability of free chorine.

A significant advantage of solutions prepared according to the invention is the purity of their ingredients. Applicant has spent years preparing and testing various disinfecting solutions and has come to realize that strict compliance to process and highly-pure ingredients results in an unexpected improvement in shelf-life. It is thought that this improvement in shelf-life is attributable, at least in part, to a more stable dynamic equilibrium. The presence of contaminants, even at low levels, catalyze reactions within the solution that lead to its destabilization and shortened shelf-life. The absence of these contaminants or their reduction below a critical threshold prevents such catalysis or causes the reactions to proceed at a much reduced rate.

In one embodiment, the invention provides a method of purifying a volume of water by one or more of the following processes: steam distillation, micron filtration, reverse osmosis, or ozonization. The processed water must have dissolved solids of no greater than two parts per million to meet all medical/lab and/or food standards. Deionized water is not one of the preferred components because it is prepared by a chemical process that uses specially manufactured ion-exchange resins, which exchange hydrogen and hydroxide ions for dissolved minerals. In other words, it leaves behind hydrogen and hydroxide ions in the water.

In another embodiment, the invention provides a method wherein the sodium chloride utilized must be pure, CAS# 7647-14-5 (no additives such as iodine or anti-caking agents), medical, kosher canning or pharmaceutical grade with an assay of 99-100%.

In another embodiment, the invention provides a method wherein the carbon dioxide gas, added as a catalytic inhibitor agent to create a dynamic equilibrium of the HOCl/NaCl, must be food grade or better and the carbon dioxide purity must be equal to or greater than 99.9%.

In another embodiment, the invention provides a method wherein the carbon dioxide gas, added as a catalytic inhibitor agent to create a dynamic equilibrium of the HOCl/NaCl, must be lab drade and the CO₂ purity must be equal to or greater than 99.999%, CAS # 124-38-9.

In another embodiment, the invention provides a method wherein the sulfamic acid, added as a catalytic inhibitor agent to create a dynamic equilibrium of the HOCl/NaCl, is technical grade (CAS # 5329-14-6) with an assay of 99.5%.

In another embodiment, the invention provides a method to build, operate and control the electrolysis device. The hypochlorite cell assembly has a center cylindrical housing, constructed from six-inch diameter, thick-walled non-conductive schedule 40 PVC pipe. The cartridge contains a total of eight electrodes, all manufactured from grade 2 titanium. Six bipolar electrodes are coated on one side with ruthenium oxide, iridium oxide, and titanium oxide and uncoated on the other side. A dedicated cathode electrode, on one side of the stack, is uncoated and there is a dedicated anode electrode that is coated on both sides with ruthenium oxide, iridium oxide, and titanium oxide on the other side of the stack. Coating just one side of the six center layers of the electrodes creates a highly efficient use of the electrode surface function, allowing it to process the electric voltage in/out of the same electrode, using less surface loss of the conversion power of the voltage and less oxidation of the mixture by bubble fractionation. This efficient cell design was developed for producing extended life Hypochlorous acid and has 60 to 75 square cm of surface area per liter of mixture. The hypochlorite production tank is cylindrical with capacity of 20 liters, based on electrode surface area of 1,200 to 1,500 square centimeters. The production tank is HDPE, Nalgene, or PVC, preferably Nalgene chemical grade.

In another embodiment, the invention provides a hypochlorite generator controller (smart power supply assembly) with the following features: 1) product batch timer, 2) pre-selected electrical voltage set-points, 3) temperature and voltage alarms, which will shut off the process to protect the system and the batch if the temperature is too high or the voltage too high/low.

Applicant has found, for example, that preparing solutions according to the invention is optimized at temperatures between about 45° C. and about 80° C., more preferably between about 54° C. and about 60° C. Temperatures below this range tend to propagate insufficient chlorine, while temperatures above this range promotes gassing off of the chlorine.

In another embodiment, a salt (e.g., sodium chloride) is dissolved in water at the following proportions:
1) for maximum chlorine production (up to 8,000 mg/L), 28 grams per liter;
2) for ultra-low salt production (up to 5,000 mg/L), 10 grams per liter.

The ultra-low salt batch requires a longer processing time and produces a lower concentration of chlorine.

In another embodiment, a solution is electrolyzed by applying 30 VDC while the smart power supply assembly control functionality of the software closely monitors the current. The voltage is decreased during the process in order to prevent exceeding a preset maximum current level of 30 amps.

In another embodiment, a timer is set dependent on 1) batch size, 2) strength requirement, and 3) salt content. For a 20 liter batch, a processing time of 60 minutes for 28 grams per liter salt solution and 95 minutes for 10 grams per liter salt solution. As the salt is electrolyzed, the water is less conductive and the displayed current and voltage can be used to determine the increase of Hypochlorous acid and the need to continue the process for a longer time.

In another embodiment, the increase in salt solution temperature masks the effect of reduced salt content in terms of electrical conductivity. Manufacturing standards developed through practical experience determined by the desired level of mg/L of chlorine is substituted for the volts/amps readings. Also, careful attention to the temperature of the salt solution avoids reaching temperatures which may cause the chlorine to off gas.

In another embodiment, after the selected period of processing time, 60 minutes for 28 grams of salt or 90 minutes for 10 grams of salt, the sodium hypochlorite is ready for dilution to the end user's requisite strength. At 28 grams per liter of salt, the resulting sodium hypochlorite is 8,000 mg/L. At 10 grams per liter of salt, the resulting sodium hypochlorite is 5,000 mg/L. Dilutions are made using purified water that has dissolved solids of no greater than two parts per million, which is added slowly to the sodium hypochlorite to reduce gas-off.

In another embodiment, the pH is then lowered to ˜6.0-7.0 by gently dispersing the catalyst inhibitor carbon dioxide gas through the diluted batch with a perforated nozzle while keeping careful track of pH. The use of gas provides exacting control so there is no overshoot of the (+/−) 6-7 pH. Using carbon dioxide gas also eliminates the possibility of introducing unwanted characteristics and/or impurities, as is the case when using a liquid acid.

The carbon dioxide is supplied to the nozzle at, for example, seven psi with a flow rate of 140 cubic centimeters per second. These parameters will vary depending on volume of liquid and concentration of chlorine. For example, taking 20 liters of sodium hypochlorite at 8,000 mg/L diluted to make 160 liters at 1,000 mg/L would require seven minutes, paying close attention to the pH meter to reach a pH of 6-7, at which point the solution is primarily Hypochlorous acid (+/−90%). Thus, the process slowly mixes carbonic acid (H₂CO₃) formed in the water with sodium hypochlorite in order to make Hypochlorous acid the predominant chlorine species.

In another embodiment, sulfamic acid is added as a catalytic inhibitor agent to create a dynamic equilibrium of the HOCl, working with the inhibitor carbon dioxide mixture. This preserves the chlorine content by reducing gasification of the diluted solution and/or reversion to sodium hypochlorite. For extended storage, at 1,000 mg/L free available chlorine (FAC), 0.3-1 grams of sulfamic acid is added, carefully monitoring the solution with a pH meter. For different volumes, and/or concentrations, the quantity of sulfamic acid is adjusted proportionally (e.g., doubling the volume of liquid requires doubling the quantity of sulfamic acid). The sulfamic acid has a slight acidification effect, lowering the pH of the solution to 4-7.

In another embodiment, for long term storage for over one year, opaque (e.g., black, blue, or amber) glass bottles are required.

In another embodiment, plastic containers can be used, such as thick walled, opaque HDPE bottles for shorter storage time periods up to one year.

The terminology used herein is for the purpose of describing particular embodiments only and is not intended to be limiting of the invention. As used here, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. When a range is used to express a possible value using two numerical limits X and Y (e.g., a concentration of X ppm to Y ppm), unless otherwise stated the value can be X, Y, or any number between X and Y.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and their practical application, and to enable others of ordinary skill in the art to understand the invention.

What is claimed is:

1. A method of preparing a Hypochlorous acid solution, the method comprising:
electrolyzing a salt solution of purified water and substantially pure sodium chloride to form a Hypochlorous acid solution;
introducing into the Hypochlorous acid solution a quantity of carbon dioxide gas; and
introducing into the Hypochlorous acid solution a quantity of sulfamic acid.

2. The method of claim 1, further comprising:
preparing the solution by adding to a volume of purified water a quantity of substantially pure sodium chloride.

3. The method of claim 1, wherein the pH of the Hypochlorous acid solution, after introduction of the carbon dioxide gas and the sulfamic acid, is between about 6.0 and about 7.0.

4. The method of claim 1, wherein the pH of the Hypochlorous acid solution, after introduction of the carbon dioxide gas and the sulfamic acid, is between about 4.5 and about 5.5.

5. The method of claim 1, wherein the purified water is water purified by at least one process selected from a group consisting of: steam distillation, micron filtration, reverse osmosis, and ozonization.

6. The method of claim 1, further comprising:
preparing the purified water using at least one process selected from a group consisting of: steam distillation, micron filtration, reverse osmosis, and ozonization.

7. The method of claim 1, wherein the substantially pure sodium chloride is at least 99% pure and free of additives.

8. The method of claim 7, wherein the substantially pure sodium chloride is present in the salt solution at a concentration between about 10 grams per liter of purified water and about 28 grams per liter of purified water.

9. The method of claim 1, wherein electrolyzing the salt solution includes applying about 30 VDC to the salt solution at a maximum current level of about 30 amps.

10. The method of claim 1, wherein the quantity of carbon dioxide gas is sufficient to lower a pH of the Hypochlorous acid solution to between about 6.0 and about 7.0.

11. The method of claim 1, wherein the quantity of sulfamic acid is equivalent to a concentration of between about 0.3 grams per 1,000 mg/L free available chlorine in the Hypochlorous acid solution and about 1.0 gram per 1,000 mg/L free available chlorine in the Hypochlorous acid solution.

12. The method of claim 1, wherein the quantity of sulfamic acid is sufficient, in combination with the quantity of carbon dioxide gas, to lower a pH of the solution to between about 6.0 and about 7.0.

13. The method of claim 1, wherein the quantity of sulfamic acid is sufficient, in combination with the quantity of carbon dioxide gas, to lower a pH of the solution to between about 4.5 and about 5.5.

14. The method of claim 1, wherein each of the electrolyzing step and the introducing steps is carried out at a solution temperature between about 45° C. and about 80° C.

15. The method of claim 14, wherein the temperature is between about 54° C. and about 60° C.

16. A Hypochlorous acid solution prepared according to the method of claim 1.

17. A liquid solution comprising:
Hypochlorous acid as the predominant chlorine species,
wherein the solution has a pH between about 6.0 and about 7.0 and is shelf-stable for at least up to one year.

18. The liquid solution of claim 17, which is shelf-stable for more than one year.

19. The liquid solution of claim 17, wherein the free available chlorine (FAC) concentration is between about 250 mg/L and about 5,000 mg/L.

20. The liquid solution of claim 17, wherein the free available chlorine (FAC) concentration is about 1,000 mg/L.
